(19) United States
(12) Patent Application Publication
(10) Pub. No.: US 2020/0156522 A1
(43) Pub. Date: May 21, 2020

(54) VEHICLE HEAD RESTRAINT ACTUATION MECHANISMS

(71) Applicant: GM Global Technology Operations LLC, Detroit, MI (US)

(72) Inventors: Daniel W. Booth, Troy, MI (US); Jesse Kriesel, Oxford, MI (US); Joseph Lombardi, Royal Oak, MI (US); Stephanie C. Radion, Bloomfield Hills, MI (US); Heidi H. McAdoo-Wilson, Tecumseh (CA)

(21) Appl. No.: 16/192,299

(22) Filed: Nov. 15, 2018

(51) Int. Cl. B60N 2/72; B60N 2/853

(52) U.S. Cl. CPC B60N 2/72; B60N 2002/899; B60N 2/853

(57) ABSTRACT

A head restraint for a vehicle seat is provided. In one embodiment, the head restraint includes a body defining an exterior surface, where the exterior surface of the body is divided into one or more touch zones. The head restraint also includes a material configured to generate a variable resistance in response to receiving a user input. The material located underneath the exterior surface of the head restraint where the one or more touch zones are located. The head restraint also includes one or more actuation mechanisms configured to move the head restraint relative to the vehicle seat. Finally, the head restraint includes a control module in electrical communication with the material and the one or more actuation mechanisms, wherein the control module executes instructions to receive the variable resistance from the material and determine at least one command signal.

### INTRODUCTION

The present disclosure relates to vehicle head restraints. More particularly, the present disclosure relates to actuation mechanisms for vehicle head restraints.

Vehicle seats include a head restraint for providing comfort and support to an occupant's head. Head restraints typically include a trim cover for enclosing a cushion and an actuation mechanism. The actuation mechanism is configured to move the head restraint up and down in a vertical direction with respect to the vehicle seat. The actuation mechanism may also provide movement in the fore and aft direction as well. An adjustment button is connected to the actuation mechanism and is pressed or otherwise selected by a passenger to adjust the position of the head restraint.

The space required to connect the actuation mechanism with the adjustment button limits the location of the adjustment button along an exterior surface of the head restraint. Specifically, the adjustment button is typically limited to one of the surfaces located along the sides of the head restraint. The shape or profile of the head restraint is constrained by the packaging requirements of the adjustment button and the actuation mechanism as well. Specifically, the side surfaces of the head restraint may need to be sized to accommodate the adjustment button. As a result, the shape of the head restraint is sometimes large and awkward in order to accommodate the adjustment button and the actuation mechanism. Furthermore, the position of the adjustment button on the head restraint may be in a location that is difficult for a passenger to reach and select.

Thus, while current head restraints achieve their intended purpose, there is a need for a new and improved head restraint that does not include the above-mentioned limitations.

### SUMMARY

According to several aspects, a head restraint for a vehicle seat is disclosed. The head restraint includes a body defining an exterior surface, where the exterior surface of the body is divided into one or more touch zones. The head restraint also includes a material configured to generate a variable resistance in response to receiving a user input. The material is located underneath the exterior surface of the head restraint where the one or more touch zones are located. The head restraint also includes an actuation mechanism configured to move the head restraint relative to the vehicle seat and a control module in electrical communication with the material and the actuation mechanism. The control module executes instructions to receive the variable resistance from the material and determine at least one command signal based on the variable resistance. The command signal instructs the actuation mechanism to move the head restraint relative to the vehicle seat.

In another aspect of the disclosure, the material is a pressure sensitive material including two electrically conductive layers of material and a partially conductive material located between the two electrically conductive layers.

In yet another aspect of the disclosure, the material is a quantum tunneling composite (QTC).

In still another aspect of the disclosure, the touch zones are positioned in areas along the exterior surface of the head restraint relative to their respective direction of motion.

In another aspect of the disclosure, the head restraint further comprises a first touch zone positioned along an upper portion of the head restraint. The first touch zone is associated with movement of the head restraint in a downward direction.

In yet another aspect of the disclosure, the head restraint further comprises a second touch zone positioned along a lower portion of the head restraint. The first touch zone is associated with movement of the head restraint in an upward direction.

In another aspect of the disclosure, a head restraint for a vehicle seat is disclosed. The head restraint includes a body defining an exterior surface and a selection mechanism located along the exterior surface of the body. The selection mechanism is configured to receive user input to move the head restraint relative to the vehicle seat. The head restraint further includes a ball joint comprising a stud portion and a socket. The socket is operatively connected to the selection mechanism and the stud portion is pivotable within the socket. The head restraint also includes an actuation mechanism operatively connected to the selection mechanism by the ball joint. The ball joint provides a pivotable connection between the selection mechanism and the actuation mechanism.

In yet another aspect of the disclosure, the selection mechanism includes a mechanically actuated push button.

In still another aspect of the disclosure, the selection mechanism includes an annular member shaped to surround the push button.

In another aspect of the disclosure, the exterior surface of the head restraint includes a trim material. The trim material defines an aperture shaped to surround the annular member.

In yet another aspect of the disclosure, the annular member and the mechanically actuated push button are constructed of a polymer, metal, or a composite material.

In still another aspect of the disclosure, the stud portion of the ball joint defines a ball that includes a substantially hemispherical profile.

In another aspect of the disclosure, the socket defines a cavity shaped to receive the ball of the stud portion.

In yet another aspect of the disclosure, the stud portion defines a plunger that projects from the ball.

In still another aspect of the disclosure, the plunger extends into a core portion of the head restraint.

In another aspect of the disclosure, the core portion houses the actuation mechanism.

In yet another aspect of the disclosure, the selection mechanism is part of a trim material of the head restraint.

In still another aspect of the disclosure, the selection mechanism is an embossed indicator disposed along the trim material.

In another aspect of the disclosure, a head restraint for a vehicle seat is disclosed. The head restraint includes a body defining an exterior surface and a selection mechanism located along the exterior surface of the body. The selection mechanism is configured to receive user input to move the head restraint relative to the vehicle seat. The head restraint also includes a flexible plunger operatively connected to and providing three dimensional movement to the selection mechanism. The head restraint also includes an actuation mechanism operatively connected to the selection mechanism by the flexible plunger.

In yet another aspect of the disclosure, the actuation mechanism is either a fluid or a cable system configured to transmit mechanical force.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side view of an exemplary vehicle seat including the disclosed head restraint according to an exemplary embodiment;

FIG. 2 is a perspective view of the head restraint shown in FIG. 1, where the head restraint is actuated based on two or more touch zones according to an exemplary embodiment;

FIG. 3 is a cross-sectioned view of the head restraint, where a trim material and a pressure sensitive material are shown according to an exemplary embodiment;

FIG. 4 illustrates an operator or passenger compressing the pressure sensitive material shown in FIG. 3 according to an exemplary embodiment;

FIG. 5 is an illustration of an exemplary actuating mechanism for the head restraint according to an exemplary embodiment;

FIG. 6 is an alternative embodiment of the head restraint shown in FIG. 1 including a ball joint connected to a selection mechanism or button according to an exemplary embodiment;

FIG. 7 is a perspective view of ball joint shown in FIG. 6 according to an exemplary embodiment;

FIG. 8A is a cross-sectioned view of another embodiment of the head restraint according to an exemplary embodiment;

FIG. 8B is a front view of the head restraint shown in FIG. 8A, where the trim material includes an embossed or raised button according to an exemplary embodiment; and

FIG. 9 is an alternative embodiment of the head restraint shown in FIGS. 6 and 7, where a flexible plunger is used instead of the ball joint according to an exemplary embodiment.

### DETAILED DESCRIPTION

The following description is merely exemplary in nature and is not intended to limit the present disclosure, application, or uses.

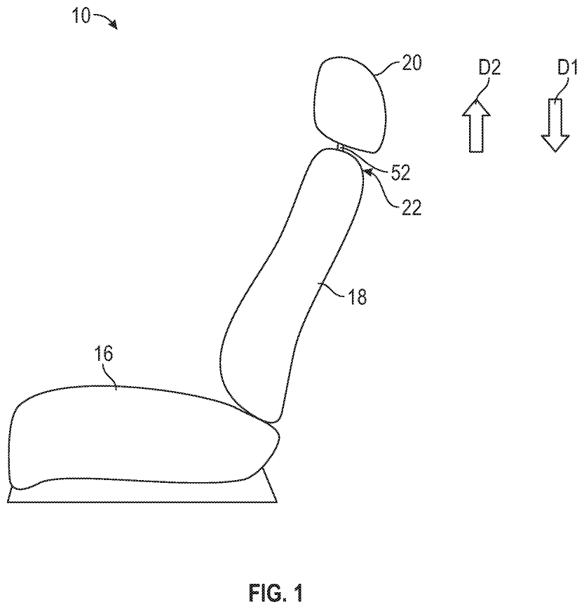

Referring to FIG. 1, a vehicle seat 10 is shown. The vehicle seat 18 includes a seat portion 16, a back side 18, and a head restraint 20. The head restraint 20 is connected to an upper portion 22 of the back side 18 of the vehicle seat 10. The head restraint 20 is moveable relative to the vehicle seat 10. In one embodiment, the vehicle seat 10 may be part of an automobile such as a car, van, or sport utility vehicle. Although a front passenger seat is shown in FIG. 1, it is to be appreciated that the vehicle seat 10 may also be a rear passenger seat. Furthermore, it is to be appreciated that the vehicle seat 10 is not limited to automobiles. Instead, the vehicle seat 10 may be used in any device for transporting passengers. For example, in another embodiment the vehicle seat 10 may be part of an aircraft.

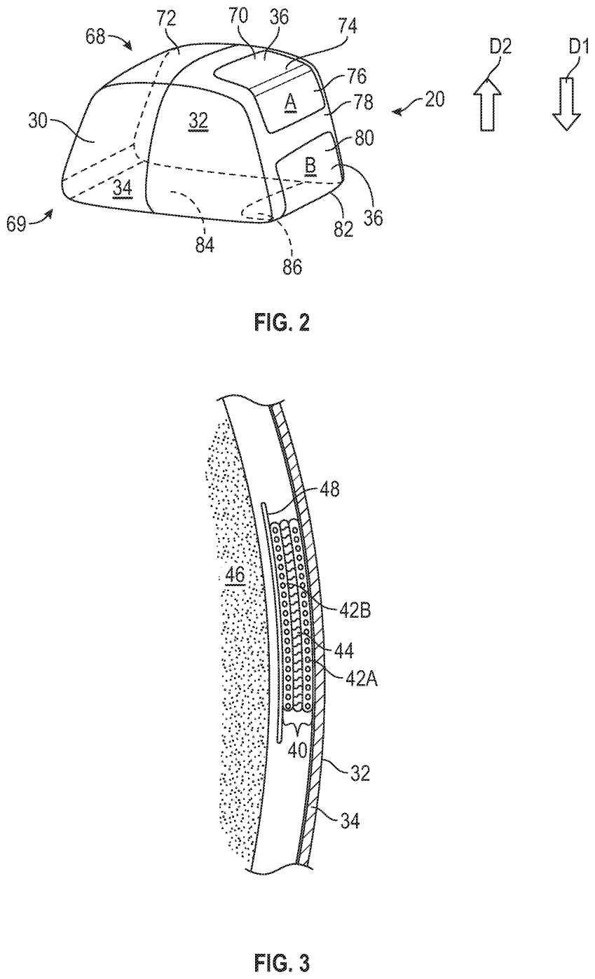

FIG. 2 is a perspective view of the head restraint 20 shown in FIG. 1. The head restraint 20 includes a body 30 defining an exterior surface 32, where the exterior surface 32 of the body is divided into one or more touch zones 36. The touch zones 36, which are described in greater detail below, represent pre-defined areas of the exterior surface 32 that an occupant exerts a force against to actuate the head restraint 20 relative to the vehicle seat 10 (FIG. 1). The exterior surface 32 is defined by a covering or trim material 34 that is used to cover the vehicle seat 10 (FIG. 1). Some examples of trim materials include, but are not limited to, leather, nylon fabric, or vinyl fabric.

Referring to both FIGS. 2 and 3, the head restraint 20 also includes a material 40 configured to generate a variable resistance R based on an amount of pressure exerted thereon by an occupant of the vehicle seat 10. In the embodiment as shown, the material 40 is a pressure sensitive material is located within the body 30 of the head restraint 20, underneath the trim material 34. Specifically, the material 40 is located underneath the trim material 34 of the head restraint 20 where the touch zones 36 are located. In other words, the material 40 is only located underneath the exterior surface 32 of the head restraint 20 in the touch zones 36. Therefore, the variable resistance R is generated in response to an occupant pressing or otherwise exerting pressure against one of the touch zones 36 of the head restraint 20.

FIG. 3 is a cross-sectioned view of the head restraint 20 illustrating an occupant's finger 38 exerting a force against the material 40. In the embodiment as shown, the material 40 includes two electrically conductive layers of material 42A, 42B, and a partially conductive material 44 located between the two electrically conductive layers of material 42A, 42B. In one embodiment, a stiffening layer 48 may also be disposed underneath the lower electrically conductive layer of material 42B. For example, the stiffening layer 48 is constructed of biaxially-oriented polyethylene terephthalate (BoPET). A filling material 46, such as foam, is located underneath the material 40 and the stiffening layer 48.

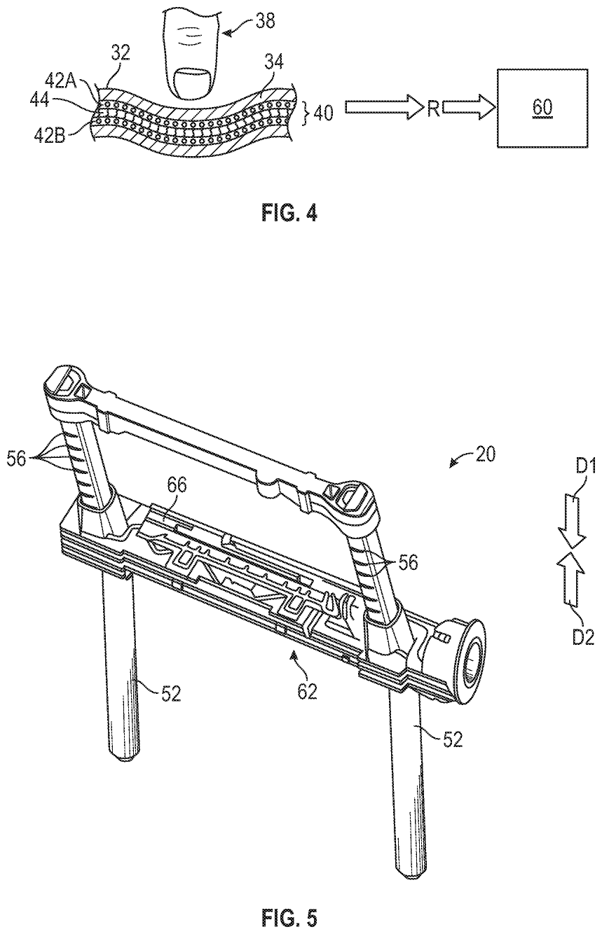

In one embodiment, the electrically conductive layers of material 42A, 42B may be constructed of a fabric, where electrically conductive material arranged in tracks or strips (not seen in the figures) are disposed along the fabric. The partially conductive material 44 includes conductive fibers (not illustrated) disposed therein. The partially conductive material 44 is configured to act as an insulator in the resting state or non-compressed state. However, turning to FIG. 4, when compressed the conductive fibers located within the partially conductive material 44 contact one another and thereby allow electrical current to flow between the electrically conductive layers of material 42A, 42B. Thus, the partially conductive material 44 acts as an insulator when no pressure or zero force is exerted. However, as pressure or force is exerted upon the material 40, then the conductive fibers move closer to one another, thereby changing the resistance. Accordingly, the resistance of the pressure sensitive material is a function of the force or pressure exerted thereon.

In another embodiment, the material 40 is a quantum tunneling composite (QTC), which is a variable resistance pressure sensitive material. The QTC material acts as an insulator when no pressure or zero force is applied. However, as pressure or force is exerted upon the pressure sensitive material, then conductive particles of the QTC material move closer to other conductive particles and change the resistance. Thus, the resistance of the QTC material is a function of the force or pressure exerted thereon. In still another embodiment, the material 40 may include capacitive pressure sensors instead, which provide a variable resistance based on a user's touch. Therefore, the material 40 is configured to generate a variable resistance R in response to receiving a user input upon of the touch zones 36 of the head restraint 20.

Referring to FIGS. 3, 4, and 5 a control module 60 is in electrical communication with the material 40 and one or more actuation mechanisms 62. The actuation mechanism 62 is mechanical device configured to provide the motion required to move the head restraint 20, and is shown in FIG. 5. The control module 60 may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the control module 60 may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The control module 60 executes instructions to receive the variable resistance R generated by the material 40. In response to receiving the variable resistance R, the control module 60 determines at least one command signal based on a value the variable resistance R. The command signal instructs the actuation mechanism 62 to move the head restraint 20 relative to the vehicle seat 10 (FIG. 1). In one embodiment, the touch zones 36 of the head restraint 20 are each associated with a unique actuation direction. In other words, each touch zone 36 provides a unique actuation motion of the head restraint 20. The actuation motion of the head restraint 20 is determined based on the direction of the force exerted upon the touch zone 36.

In the embodiment as shown in FIG. 2, a first touch zone A is positioned along an upper portion 68 of the head restraint 20 and is associated with movement of the head restraint 20 in a downward direction. Specifically, the first touch zone A is positioned along a portion 70 of an upper surface 72, along an edge 74, and extends along an upper portion 76 of a side surface 78 of the head restraint 20. In one embodiment, the head restraint 20 is configured to move in a first downward direction D1 in response to a force exerted upon the first touch zone A. More specifically, in response to a force exerted in a downward direction as the user exerts force along the upper surface 72 or along the edge 74 the control module 60 instructs the actuation mechanism to move the head restraint in the downward direction D1. The control module 60 also instructs the actuation mechanism to move the head restraint 20 in the downward direction D1 when a force angled in the downward direction is exerted upon the side surface 78.

A second touch zone B is positioned along a lower portion 69 of the head restraint 20 and is associated with movement of the head restraint 20 in an upward direction. The second touch zone B is positioned along a lower portion 80 of the side surface 78, along an edge 82, and extends along a portion 86 of the lower surface 84 (shown in phantom line) of the head restraint 20. The head restraint 20 is configured to move in a second, upward direction D2 in response to a force exerted upon the second touch zone B. More specifically, in response to a force exerted in an upward direction as the user exerts force along the lower surface 84 or along the edge 82 the control module 60 instructs the actuation mechanism 62 (FIG. 5) to move the head restraint 20 in the upward direction D2. The control module 60 also instructs the actuation mechanism 62 to move the head restraint 20 in the upward direction D2 when a force is exerted upon the side surface 78, in an angled upward direction as well.

Although FIG. 2 illustrates a specific arrangement of the first touch zone A and the second touch zone B, it is to be appreciated that this arrangement is merely exemplary in nature. The touch zones 36 are positioned in areas along the exterior surface 32 of the head restraint 20 relative to their associated direction of motion. Therefore, an occupant may be able to intuitively understand which touch zone 36 to select in order to actuate the head restraint 20. For example, an occupant would likely be able to understand that the touch zone A is associated with the downward motion while the touch zone B is associated with the upward motion. For example, in another embodiment the occupant may press against both sides of the head restraint 20 simultaneously, while also exerting a force in either an upward direction or a downward direction. Furthermore, although a pressure sensitive material is described, it is to be appreciated that in another embodiment the head restraint 20 may include one or more capacitive sensors that are disposed along the exterior surface 32 (FIG. 2) of the head restraint 20 instead.

FIG. 5 illustrates the actuation mechanism 62, which is configured to move the head restraint 20 relative to the vehicle seat 10 (FIG. 1). Specifically, FIG. 5 is an illustration of a pair of vertically extending rods 52 that are configured to provide vertical motion to the head restraint 20. The vertically extending rods 52 connect the head restraint 20 to the vehicle seat 10 (the vertically extending rods 52 are also seen in FIG. 1). Referring to both FIGS. 1 and 5, the head restraint 20 is configured to slide relative to the vehicle seat 10 in the downward direction D2 and the upward direction D1 along the vertically extending rods 52. As seen in FIG. 5, the vertically extending rods 52 are disposed substantially parallel with respect to one another. Both vertically extending rods 52 define a plurality of cavities or notches 56 that are arranged in a series along a length of a corresponding one of the rods 52. The notches 56 are each shaped to receive a retaining pin (not shown in FIG. 5). When a retaining pin is engaged with a corresponding notch 56, this secures the head restraint 20 into a specific vertical position relative to the vehicle seat 10 (FIG. 1). Accordingly, when the retaining pins are engaged with respective notches 56, the head restraint 20 is unable to move upward and downward relative to the vehicle seat 10.

The actuation mechanism 62 also includes a slide 66 that is operatively coupled to the retaining pins (not visible in FIG. 5). The slide 66 may be spring loaded and is normally in a locked position. When the slide 66 is in the locked position, the retaining pins are engaged with their respective notches 56 in the vertically extending rods 52. When actuated out of the locked position, the slide 66 is configured to urge the retaining pins out of their respective notches 56. In one embodiment, the slide 66 is actuated in a direction substantially transverse with respect to the two vertically extending rods 52, which in turn urges the retaining pins out of their respective notches 56. When the retaining pins are disengaged with their respective notches 56, the head restraint 20 slides in the upward D2 and the downward D1 directions. However, once the retaining pins are inserted back into their respective notches 56, then the head restraint 20 is fixed in place. It is to be appreciated that the actuation mechanism 62 shown in FIG. 5 is merely exemplary in nature and that a number of other mechanisms to move the head restraint 20 may be used as well. Furthermore, although FIG. 5 illustrates an actuation mechanism 62 for actuating the head restraint 20 in the up and down directions, a mechanism for moving the head restraint 20 in the fore and aft direction may be used as well.

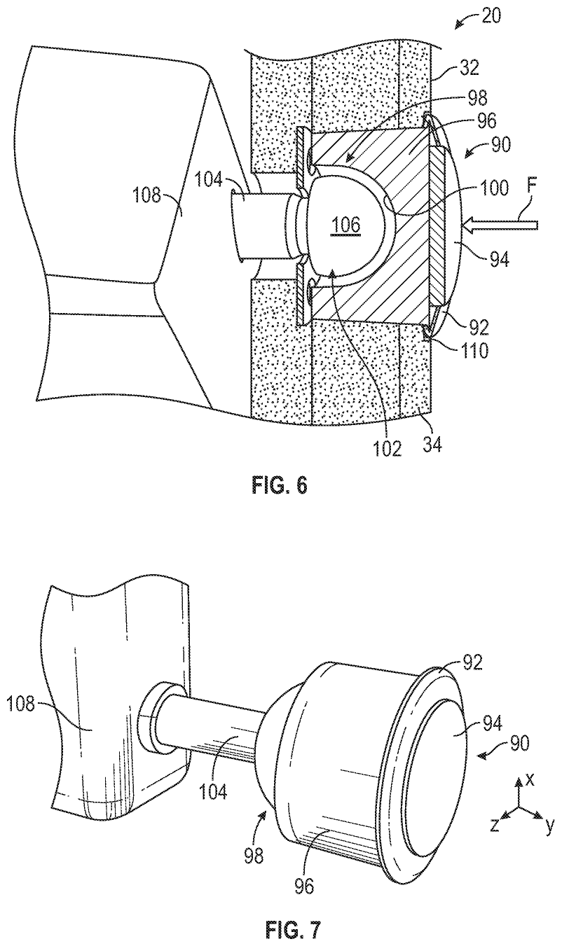

FIG. 6 is a cross-sectioned view of an alternative embodiment of the head restraint 20. In the embodiment as shown in FIG. 6, a selection mechanism 90 is provided instead of the touch zones 36 as shown in FIG. 2. In other words, the selection mechanism 90 is configured to receive user input, where the user input actuates the actuation mechanism 62 (FIG. 5) and moves the head restraint 20 relative to the vehicle seat 10 (FIG. 1). In one embodiment, the selection mechanism 90 may be a mechanically actuated push button operatively connected to the actuation mechanism 62 (FIG. 5). In response to an occupant exerting a normal force F upon the selection mechanism 90 (e.g., pressing the push button), the slide 66 (FIG. 5) is actuated from the locked position and into an unlocked position, which in turn disengages the retaining pins (not shown) from their respective notches 56. Accordingly, the head restraint 20 is free to move up and down relative to the vehicle seat 10 (FIG. 1).

Referring to FIGS. 5, 6, and 7, the selection mechanism 90 includes an annular member 92 and a cap 94 that are located along the exterior surface 32 of the head restraint 20. In the embodiment as shown, the cap 94 is part of a mechanically actuated push button that is visible to the occupant, where the occupant exerts a force against the cap 94 to actuate the head restraint 20. The annular member 92 is shaped to surround the cap 94 (i.e., the push button). An aperture 110 defined by the trim material 34 of the head restraint 20 is shaped to surround the annular member 92. The annular member 92 and the cap 94 are both constructed of materials such as, but not limited to, a polymer, metal, or a composite material.

The cap 94 is operatively connected to a housing or socket 96. As seen in FIGS. 6 and 7, the socket 96 is part of a ball joint 98. The socket 96 defines an internal cavity 100 shaped to receive a ball 106 of the stud portion 102. It is to be appreciated that FIG. 7 is a perspective view of the ball joint 98, however, the socket 96 includes a slightly different shape when compared to the illustration in FIG. 6. Referring specifically to FIG. 6, the ball 106 of the stud portion 102 defines a substantially hemispherical profile. The cavity 100 of the socket 96 is shaped to receive the ball 106 of the stud portion 102. The stud portion 102 also defines an elongated member that projects from the ball 106, which is referred to as a plunger 104. The plunger 104 extends into a core portion 108 of the head restraint 20 (the plunger 104 shown in FIG. 7 includes a slightly different shape when compared to the plunger shown in FIG. 6).

Referring to FIGS. 5,6, and 7, the core portion 108 of the head restraint 20 houses the actuation mechanism 62 (FIG. 5). Accordingly, the actuation mechanism 62 is not visible in FIGS. 6 and 7. The selection mechanism 90 is operatively coupled to the slide 66 (FIG. 5) of the actuation mechanism 62 by the plunger 104. Thus, when an occupant exerts the normal force F upon the selection mechanism 90 (i.e., the occupant exerts a force against the cap 94) in a direction towards the plunger 104, the socket 96 is also translated or moves in the direction of the normal force F. The plunger 104 is also translated in the direction of the normal force F. The plunger 104 is connected to the slide 66. Accordingly, the normal force F exerted upon the cap 94 actuates the slide 66 out of the locked position and into an unlocked position. When in the unlocked position, the slide 66 urges the retaining pins (not visible in the figures) out of their respective notches 56. When the retaining pins are disengaged with their respective notches 56, the head restraint 20 is able to slide or translate in the upward D2 and the downward D1 directions. However, once the occupant ceases to exert the normal force F upon the cap 94, the slide 66 is actuated back into and the locked position retaining pins are inserted back into their respective notches 56. Accordingly, the head restraint 20 is fixed in place.

Referring specifically to FIGS. 6 and 7, the stud portion 102 is configured to pivot within the cavity 100 of the socket 96. That is, the stud portion 102 of the ball joint 98 is configured to articulate within the socket 96. The ball joint 98 provides rotational movement in the x-axis, y-axis, and the z-axis (FIG. 7), while at the same time preventing translation along theses axes. Referring now to FIGS. 2, 6, and 7, the pivotable connection between the stud portion 102 and the socket 96 of the ball joint 98 results in greater packaging flexibility of the selection mechanism 90. Specifically, some head restraints currently available include bulky and cumbersome components. As a result, the space required to connect the actuation mechanism with the adjustment button limits the location of the adjustment button along an exterior surface of the head restraint. The adjustment button is typically limited to one of the surfaces located along the sides of the head restraint. In contrast, the disclosed selection mechanism 90 may be located in a variety of locations along the exterior surface 32 of the head restraint 20. That is, the ball joint 98 provides a pivotable connection between the selection mechanism 90 and the actuation mechanism 62 (FIG. 5), where the pivotable connection between the selection mechanism 90 and the actuation mechanism 62 allow for the selection mechanism 90 to be disposed in various locations along the exterior surface 32 of the head restraint 20. In other words, the selection mechanism 90 is not restricted to the side surface 78 of the head restraint 20 (FIG. 2).

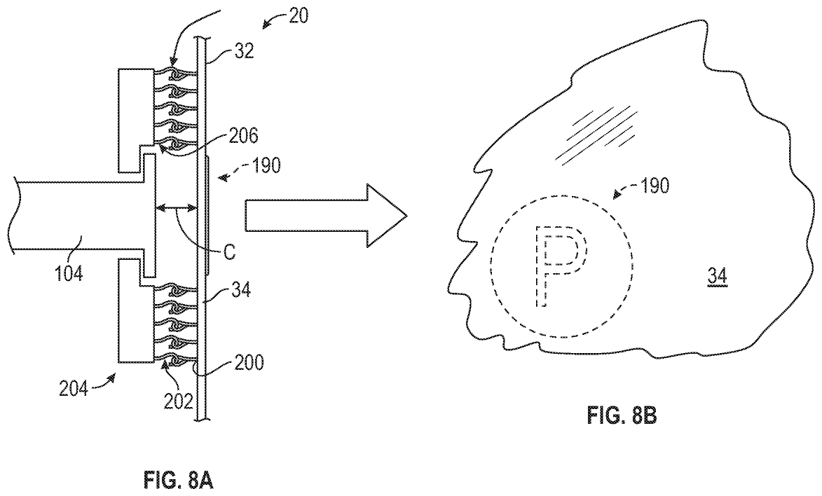

Referring to FIGS. 6 and 7, although the annular member 92 and the cap 94 are illustrated as components that are visible along an exterior of the head restraint 20, in another embodiment the selection mechanism 90 may include a button that is part of or integrated with the trim material 34. Specifically, in one embodiment, instead of a separate annular member 92 and cap 94 the selection mechanism 90 is part of the trim material 34 of the head restraint 20 (FIG. 2). Referring now to FIGS. 8A and 8B, an alternative embodiment of the head restraint 20 is shown. The head restraint 20 includes a raised or embossed indicator 190 (e.g., the “P” shown in phantom line in FIG. 8B) that is disposed along the trim material 34. The trim material 34 of the head restraint 20 defines an inner surface 200. An attachment mechanism 202 is disposed along a portion of the inner surface 200 of the trim material 34, where the attachment mechanism 202 is configured to engage with a corresponding mechanism 206 positioned on a distal end 204 of the plunger 104.

For example, in one embodiment, a hook-and-hoop fastener system may be used to attach the inner surface 200 of the trim material 34 with the plunger 104. Specifically, loop mechanisms are disposed along the inner surface 200 of the trim material 34, while hooks are disposed along the distal end 204 of the plunger 104. Although hook-and-loop fasteners are described, it is to be appreciated that other attachment approaches may be used as well. For example, in another embodiment a heat welding process may be used instead to attach the inner surface 200 of the trim material 34 to the distal end 204 of the plunger 104. Moreover, although a clearance C is illustrated between the hook-and-loop fasteners, it is to be appreciated that the clearance C has been exaggerated in order to clearly illustrate the hook-and-loop engagement between the inner surface 200 and the distal end 204 of the plunger 204.

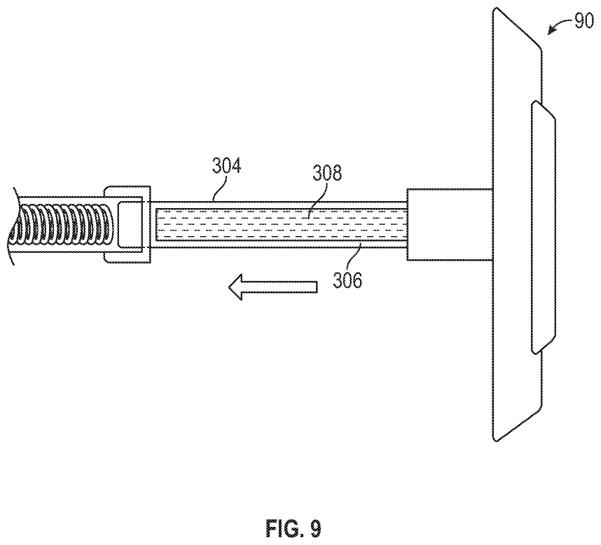

FIG. 9 is an alternative embodiment of a plunger 304 that is connected to the selection mechanism 90. That is, instead of the ball joint 98 shown in FIGS. 6 and 7, the flexible plunger 304 operatively connects the selection mechanism 90 to the actuation mechanism 62 (FIG. 5). Furthermore, the flexible plunger 304 provides three dimensional movement (i.e., in the x-axis, the y-axis, and the z-axis) to the selection mechanism 90. In one embodiment, the plunger 304 is constructed of a relatively flexible material such as, for example, segmented metal or plastic, a thermoplastic elastomer, and rubber, which allow for three-dimensional movement. In another embodiment the flexible plunger 304 is constructed of a molded polymer and is reinforced by a braided or helically wound material.

The plunger 304 defines an internal passageway 306 configured to house an actuation mechanism. In the embodiment as shown, the actuation mechanism is an actuation fluid 308. The actuation fluid 308 is a liquid or gas (i.e., the plunger 304 is either pneumatically or hydraulically powered). However, in another embodiment, the internal passageway 306 contains a cable system configured to transmit mechanical force. Specifically, in one embodiment the actuation mechanism includes flexible cable or wire surrounded by a flexible conduit or jacket. For example, the flexible cable and jacket may be a Bowden cable. The actuation mechanism is configured to fluidly connect the plunger 304 to the actuation mechanism 62 shown in FIG. 5.

Referring generally to the figures, the disclosed actuation mechanisms provide an improved approach for actuating a head restraint of a vehicle seat. More specifically, the embodiment as shown in FIG. 2 illustrates touch zones that are positioned in areas along the exterior surface of the head restraint relative to their associated direction of motion. Therefore, an occupant may be able to intuitively understand which touch zone to select in order to actuate the head restraint. Alternatively, in the embodiment shown in FIGS. 6 and 7, a pivotable connection between the actuation mechanism and a push button is shown. The pivotable connection provides greater packaging flexibility of the selection mechanism. The embodiment as shown in FIG. 9 also provides the same packaging benefits, however, a flexible plunger instead of a ball joint connection is used instead.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A head restraint for a vehicle seat, the head restraint comprising:
a body defining an exterior surface, wherein the exterior surface of the body is divided into one or more touch zones;
a material configured to generate a variable resistance in response to receiving a user input, the material located underneath the exterior surface of the head restraint where the one or more touch zones are located;
an actuation mechanism configured to move the head restraint relative to the vehicle seat; and
a control module in electrical communication with the material and the actuation mechanism, wherein the control module executes instructions to:
receive the variable resistance from the material; and
determine at least one command signal based on the variable resistance, wherein the command signal instructs the actuation mechanism to move the head restraint relative to the vehicle seat.

2. The head restraint of claim 1, wherein the material is a pressure sensitive material including two electrically conductive layers of material and a partially conductive material located between the two electrically conductive layers.

3. The head restraint of claim 1, wherein the material is a quantum tunneling composite (QTC).

4. The head restraint of claim 1, wherein the one or more touch zones are positioned in areas along the exterior surface of the head restraint relative to their respective direction of motion.

5. The head restraint of claim 4, further comprising a first touch zone positioned along an upper portion of the head restraint, wherein the first touch zone is associated with movement of the head restraint in a downward direction.

6. The head restraint of claim 5, further comprising a second touch zone positioned along a lower portion of the head restraint, wherein the first touch zone is associated with movement of the head restraint in an upward direction.

7. A head restraint for a vehicle seat, the head restraint comprising:
a body defining an exterior surface;
a selection mechanism located along the exterior surface of the body, the selection mechanism configured to receive user input to move the head restraint relative to the vehicle seat;
a ball joint comprising a stud portion and a socket, wherein the socket is operatively connected to the selection mechanism and the stud portion is pivotable within the socket; and
an actuation mechanism operatively connected to the selection mechanism by the ball joint, wherein the ball joint provides a pivotable connection between the selection mechanism and the actuation mechanism.

8. The head restraint of claim 7, wherein the selection mechanism includes a mechanically actuated push button.

9. The head restraint of claim 8, wherein the selection mechanism includes an annular member shaped to surround the push button.

10. The head restraint of claim 9, wherein the exterior surface of the head restraint includes a trim material, and wherein the trim material defines an aperture shaped to surround the annular member.

11. The head restraint of claim 9, wherein the annular member and the mechanically actuated push button are constructed of a polymer, metal, or a composite material.

12. The head restraint of claim 7, wherein the stud portion of the ball joint defines a ball that includes a substantially hemispherical profile.

13. The head restraint of claim 12, wherein the socket defines a cavity shaped to receive the ball of the stud portion.

14. The head restraint of claim 12, wherein the stud portion defines a plunger that projects from the ball.

15. The head restraint of claim 14, wherein the plunger extends into a core portion of the head restraint.

16. The head restraint of claim 15, wherein the core portion houses the actuation mechanism.

17. The head restraint of claim 7, wherein the selection mechanism is part of a trim material of the head restraint.

18. The head restraint of claim 17, wherein the selection mechanism is an embossed indicator disposed along the trim material.

19. A head restraint for a vehicle seat, the head restraint comprising:
a body defining an exterior surface;
a selection mechanism located along the exterior surface of the body, the selection mechanism configured to receive user input to move the head restraint relative to the vehicle seat;
a flexible plunger operatively connected to and providing three dimensional movement to the selection mechanism; and
an actuation mechanism operatively connected to the selection mechanism by the flexible plunger.

20. The head restraint of claim 19, wherein the actuation mechanism is either a fluid or a cable system configured to transmit mechanical force.
